(19) United States
(12) Patent Application Publication
(10) Pub. No.: US 2025/0340422 A1
(43) Pub. Date: Nov. 6, 2025

(54) Beverage Dispensing and Sanitizing System

(71) Applicants: Jason Charles Viggato, Las Vegas, NV (US); Gerardo Ernest Colucci, Las Vegas, NV (US); Alex Francis Stokes, JR., Henderson, NV (US)

(72) Inventors: Jason Charles Viggato, Las Vegas, NV (US); Gerardo Ernest Colucci, Las Vegas, NV (US); Alex Francis Stokes, JR., Henderson, NV (US)

(21) Appl. No.: 19/266,638

(22) Filed: Jul. 11, 2025

Related U.S. Application Data
(63) Continuation-in-part of application No. 18/395,211, filed on Dec. 22, 2023, now Pat. No. 12,358,773.

(51) Int. Cl. B67D 1/07

(52) U.S. Cl. CPC B67D 1/07; B67D 2001/075

(57) ABSTRACT

A system for cleaning a beverage dispenser that has a nozzle for receiving a beverage and a sanitizing fluid as a housing. The housing has an outer wall and inner wall with an annular flow path between the walls. There is a central flow path through the nozzle and a connection for fluid flow of sanitizing fluid between the central flow path and the annular flow path. The nozzle also has inlet for introduction of the sanitizing fluid. The system can be provided with a controller for controlling temperature, pressure and flow rate of the sanitizing fluid, the controller including memory for storing information when sanitization occurred.

This patent application is a continuation-in-part application of U.S. patent application Ser. No. 18/395,211, filed Dec. 22, 2023 entitled “Beverage Dispensing And Sanitizing System,” which application is incorporated in their entirety here by this reference.

### BACKGROUND

Beverage dispensing systems are well known. One example is a soda fountain with multiple dispensers, each having a lever, such as the type found in fast food restaurants. Another type is a dispensing gun of the type used by bartenders, where the gun has multiple buttons for dispensing different beverages. There are also beer dispensers.

Information regarding dispensing systems can be found in the following references:
a. US2022402743
b. WO13034190
c. GB2542601
d. Soda Gun Jetter Model SGT-200
e. CN 116714184
f. US20150102062
g. US20070140046
h. US20090014464
i. CA 3058224
j. US20170129760
k. TW 201306347
l. DE 102019109309
m. US20180086620
n. US20180111168
o. US20210316979
p. WO 2021132351
q. US20040118291

A problem with many dispensing systems is how to keep them clean and sanitized. Proper sanitization requires dependable labor to thoroughly and periodically sanitize, and such labor is not always available. Another problem is to thoroughly sanitize a system, particularly O-rings and lines, which can be difficult or sometimes impossible to access.

Accordingly, there is a need for a sanitizing system for beverage dispensing systems which are dependable, thorough, and easy to use.

### SUMMARY

The present invention is directed to a system for cleaning and preferably sanitizing a beverage dispenser, where the dispenser comprises a nozzle for receiving at least one beverage and a sanitizing fluid. Preferably the nozzle comprises a housing having an outer wall and an inner wall with an annular flow path between the walls, a central flow path through the nozzle, and a connection for fluid flow of the sanitizing fluid between the central flow path and the annular flow path. The nozzle also has an inlet for introduction of the sanitizing fluid. Typically, the sanitizing fluid is a liquid.

A heater is provided for heating sanitizing liquid before reaching the nozzle inlet.

In a preferred automated system, there is a controller for controlling the heater where the system comprises a temperature sensor for sensing the temperature of the sanitizing liquid. The temperature sensor can provide an output to the controller based on the sensed temperature.

In addition, the system typically has a pump for pumping sanitizing liquid from a sanitizing liquid source to the nozzle. There can be a controller for controlling the pump, and a flow rate sensor for sensing the flow rate of the sanitizing liquid. The flow rate sensor is capable of providing an output to the controller based on the sensed flow rate. Also, there can be a pressure sensor for sensing the pressure of the sanitizing liquid, the pressure sensor being capable of providing an output to the controller based on the sensed pressure.

Preferably the system comprises an interlock and sensor for preventing sanitizing fluid flow into the nozzle when the nozzle is not engaged to receive sanitizing fluid.

As noted, beverage dispensers typically have an O-ring to provide a seal for avoiding liquid leakage. The sanitizing fluid flows in the nozzle to sanitize the O-ring by contacting the O-ring.

In a “gun” type beverage dispensing system there is provided a holster supporting the gun including the nozzle. The holster can have a drain outlet for discharge of sanitizing fluid from the nozzle. The holster can comprise a drain outlet for discharge of sanitizing fluid from the nozzle and a nozzle inlet for introduction of sanitizing fluid into the nozzle.

In a version of the invention used with a fountain system, there are a plurality of nozzles with a valve for each nozzle for allowing and preventing beverage from flowing into the respective nozzle. Preferably there is a pressure plate for opening all of the valves simultaneously when utilizing the sanitizing fluid.

The system has a controller and a valve system so that beverage or the sanitizing liquid can be provided to the nozzle, but not to both.

Preferably the controller includes memory for storing information about when the sanitizing liquid valve was open for allowing the sanitizing liquid to sanitize and the conditions during sanitation including pressure, temperature, and flow rate.

In use of the system, sanitizing liquid is pressured into the nozzle inlet or nozzle outlet for flow through both the central flow path and the annular flow path.

Thus, the present invention provides a system that can be automated for thorough and timely sanitizing and cleaning a beverage dispensing system.

### DRAWINGS

These and other features, aspects, and advantages of the present invention will become better understood with regard to the following description, the appended claims, and accompanying drawings where:

FIG. 1 is a flow chart of a beverage gun system having features of the present invention;

FIG. 2 is a flow chart of a fountain system having features of the present invention adapted for use in a soda fountain machine;

FIG. 2A is a close-up perspective view of a cleaning attachment for the fountain system of FIG. 2;

FIG. 3 is a front elevation view of the cleaning attachment of FIG. 2A;

FIG. 4 is a front elevation view, partly in section, of a nozzle seated in the attachment of FIG. 3;

FIG. 5 is a vertical sectional view of the nozzle shown in FIG. 4 for use in the system of FIG. 2;

FIG. 6 is an exploded perspective view of a soda fountain system nozzle assembly for use in the system of FIG. 2;

FIG. 7 is a front elevation view, partly in section, of a soda gun dispensing system having features of the present invention including a holster for the soda gun;

FIG. 8 is a front elevation view of a portion of the system of FIG. 7;

FIG. 9 is a front elevation view, partly in section, showing flow of cleaning fluid in a nozzle having features of the present invention;

FIG. 10 is a front elevation view, partly in section, showing flow of cleaning fluid in the attachment of FIG. 2A

FIG. 11 is a vertical section view of a nozzle for use in a soda fountain dispenser; and

FIG. 12 is a block diagram of one embodiment of a control system suitable for operating the beverage dispensing system of the present invention.

### DESCRIPTION

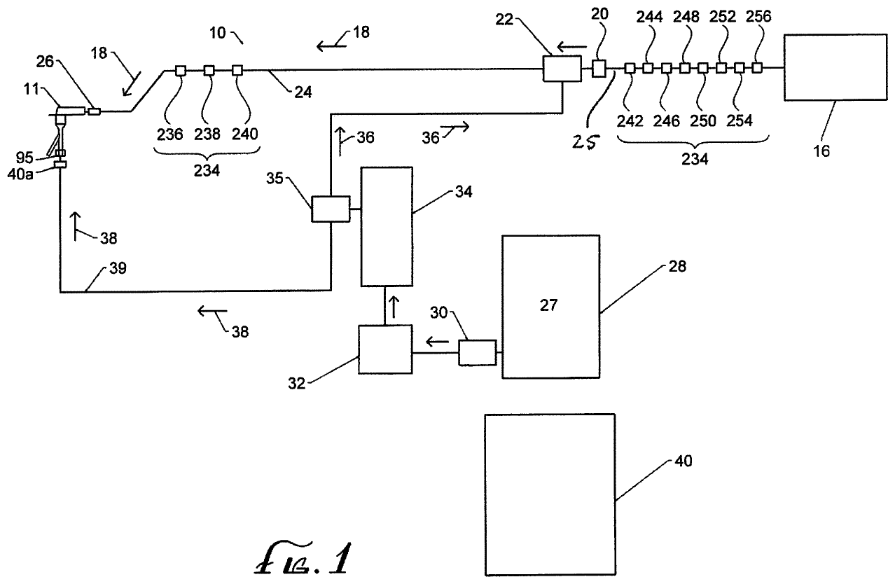

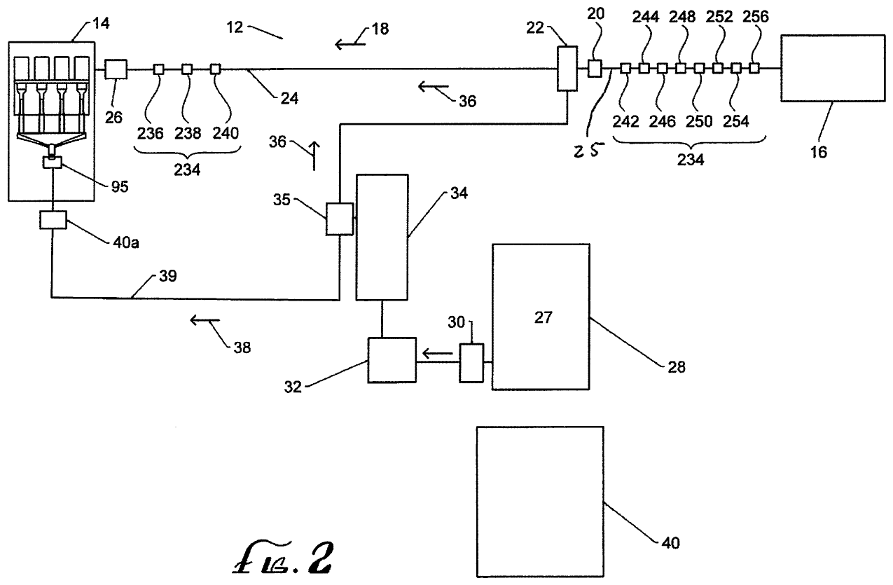

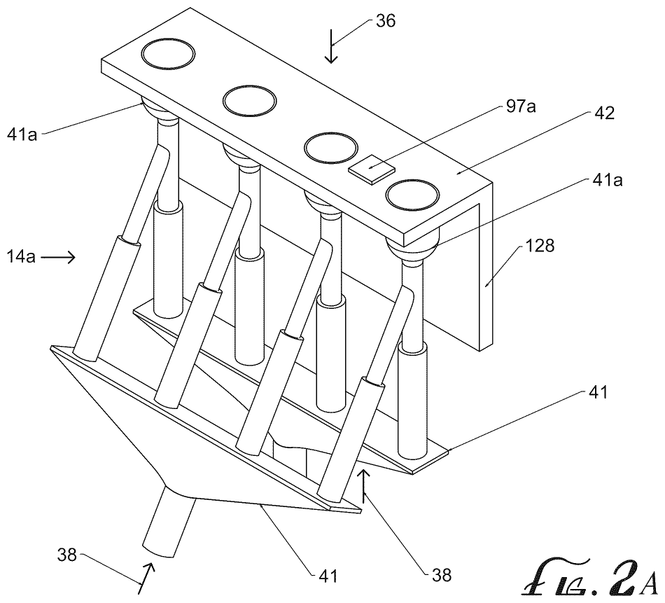

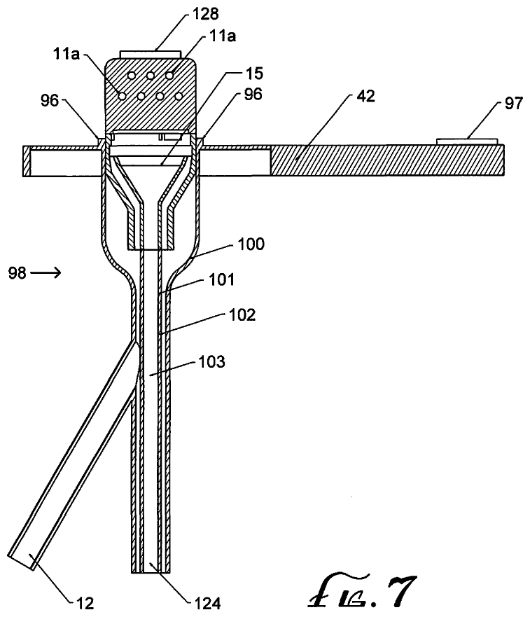

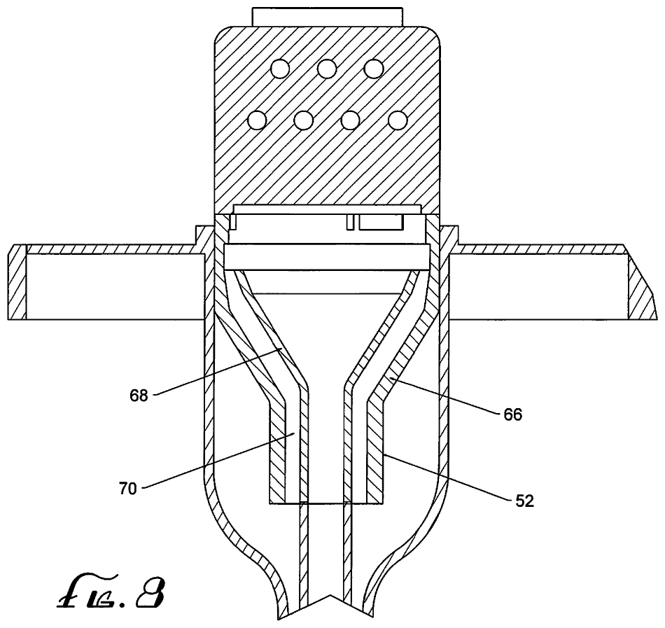

With reference to FIG. 1, there is shown a beverage dispensing system 10 utilizing a soda gun 11, the system having features of the present invention. The soda gun 11 has buttons 11a (FIGS. 7 and 8) for selecting which beverage to dispense. FIG. 2 shows a substantially similar system 12 differing in having a soda fountain dispenser 14 rather than the soda gun 11. Each system includes a unique nozzle as described below. So portions of the following description are applicable to both systems 10 and 12.

Both systems 10 and 12 dispense at least one beverage and can be sanitized with a sanitizing fluid. Although the present invention is discussed with regard to dispensing soda as the beverage, the present invention can be used with other beverages such as beer, tea, lemonade, and seltzer water.

Each system 10 and 12 includes a beverage source 16 such as a bag containing syrup. There can be more than one beverage source 16. Arrows 18 show the direction of flow of beverage from the beverage source 16 to the gun 11 or the soda fountain dispenser 14. Beverage flows from the beverage source 16 through a check valve 20 for preventing backflow, and then through an electronically controlled on/off source valve 22 through line 24, by sensors 26, and to the gun 11 or fountain 14 for dispensing.

Conventional sanitizing liquids used for cleaning beverage dispensers can be used in these systems. A sanitizing fluid 27 such as Foxx brand Superflush tap and line cleaner, Kegworks (trademark) beer line cleaning solution, or Kay (brand) 5 Sanitizer/Cleaner, is stored in a vessel 28, also referred to as a chamber. The sanitizing fluid 27 is generally a liquid.

Downstream of the vessel 28 is a sanitizing liquid outlet valve 30, which is electronically controlled, which can be opened to let sanitizing liquid out. Either the source outlet valve 22 or sanitizing liquid outlet valve 30 is open, but both are not open at the same time. Both valves can be closed at the same time. Sanitizing liquid flows through the outlet valve 30 to a pressuring device such as a pump 32 and then into a heater 34, wherein the sanitizing liquid is pumped to a desired pressure for controlling sanitizing fluid flow rate and heated to a desired temperature such as 80 to 110 degrees F. A typical flow rate for the sanitizing liquid is 0.2 to 2 gpm (gallons per minute), and usually 0.25 to 1.5 gpm. The desired pressure is also referred to as a target pressure; the desired temperature is also referred to as a target temperature.

From the heater 34 sanitizing fluid flows into a directional valve 35 which controls flow direction. Flow forwardly is shown by arrows 36 and reverse flow is shown by arrows 38. Flow forwardly includes flow through the same line 24 used for the beverage. Reverse flow is through line 39. The sanitizing liquid cleans and sanitizes the system lines and the gun 11 in FIG. 1 or fountain 14 in FIG. 2.

A controller 40 is in communication with the valves 22, 30 and 35 and pump 32 and heater 34 for controlling them. The controller 40 receives input from the sensor 26 and a sensor 40a in line 39 downstream from the soda gun 11 or soda fountain dispenser 14. The sensors 26 and 40a which can be for sensed pressure, flow rate and/or temperature, for effective use of the sanitizing liquid 27. Thus the sensors provide output to the controller 40 to have at least one of the temperature, flow rate, and pressure of the sanitizing fluid at the target temperature, the target flow rate, and the target pressure. The controller 40 also controls the valves 22, 30, and 35 for controlling if beverage is dispensed or there is a cleaning/sanitizing cycle, and the direction of flow of the sanitizing liquid, i.e. reverse or forward flow. Forward flow means the sanitizing fluid flows in the same direction as beverage enters a nozzle. Reverse flow means the sanitizing fluid flows in a direction opposite as beverage enters a nozzle.

Suitable flow and pressure sensors are I0T Flow Sensors/IoT Pressure Sensors under the model number E8FC/E8PC from Omron Electronics LLC located in Hoffman Estates, IL Another suitable flow rate sensor is available from IFN USA located in Malvern, PA under the model number US0022. A suitable temperature sensor is available from National Control Devices, LLC (NCD) in Osceola MISSOURI under Model Number RTS PT 100.

The controller 40 includes memory that is built in or can be separate. The memory can be any of the type typically used with computer systems such as solid state memory, magnetic storage medium, optical storage medium, flash memory and other machine readable medium for storing information. Among the information that can be stored and recovered is when and how long sanitizing liquid was used, how much liquid was used, and the temperature, pressure, and flow rate of the sanitizing liquid. Also, the controller can provide prompts to a user for timely implementing a sanitizing cycle. The controller can include a display for displaying information to a user, as well as prompts. Also, the controller 40 can be used with a remote device such as an iPhone phone with an app, and the remote device can be used for display of information and a visible prompt and also provide an aural prompt.

A typical soda fountain cleaning attachment 14a for the fountain dispenser 14, as shown in FIG. 2A, can accommodate four different beverages, but as is typical, soda fountain dispensers can be provided for a different number of beverages, such as six or eight different beverages.

Two manifolds 41, as shown in FIG. 2A, are provided for introducing sanitizing liquid 27, where the choice of manifold is used for introducing sanitizing liquid depends on the desired direction of flow through the system, as described below.

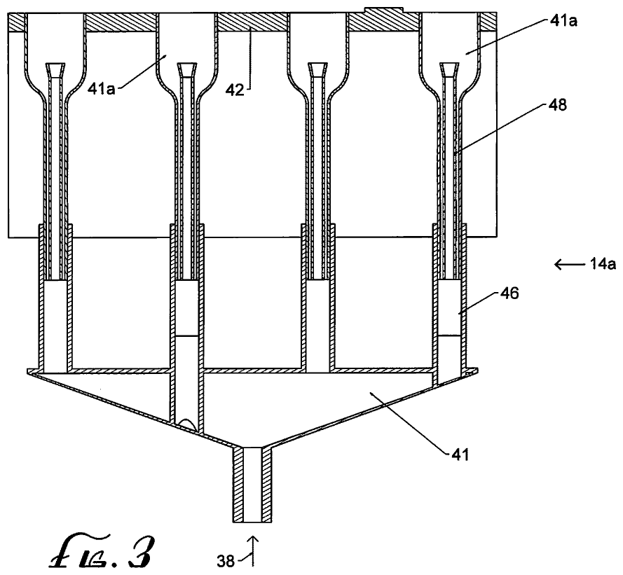

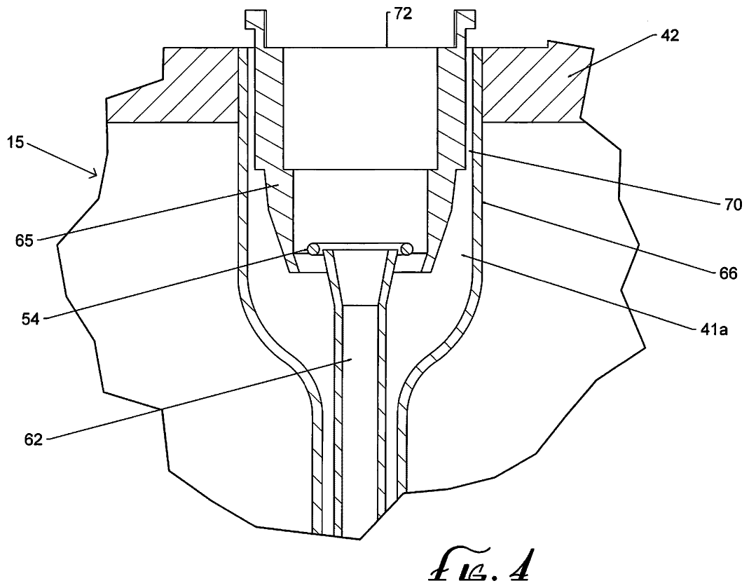

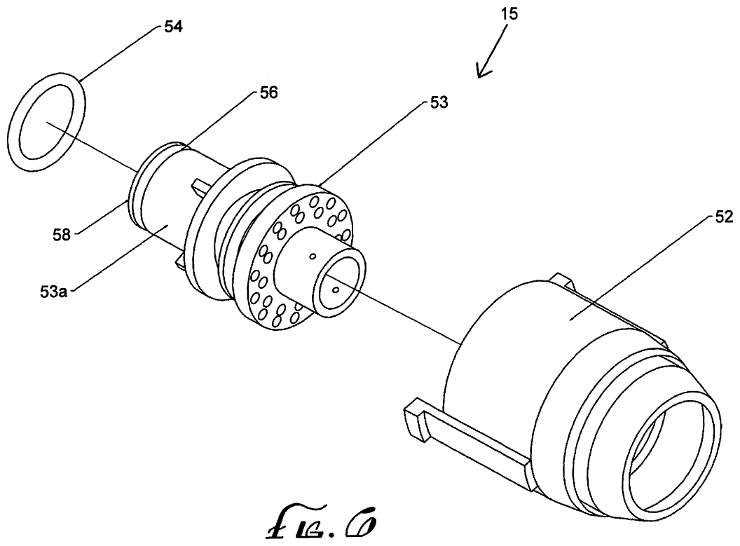

Each beverage dispenser has at least one nozzle assembly 15 (FIGS. 4 and 6) which when the system is in cleaning mode, sits in a seat 41a (FIG. 3) of the cleaning attachment 14a. A single support 42, such as an elongated plate, is provided for the nozzle assemblies 15. Each manifold 41 has pipe extensions 46 that are compression fitted over a respective discharge line 48 for sanitizing fluid from each respective nozzle assembly 15.

With regard to FIG. 6, each nozzle assembly 15 comprises the aforementioned nozzle, namely nozzle 52, a spindle diffuser 53 with a diffuser body 53a that fits into the nozzle 52 with an O-ring 54 for the spindle body 53a in a groove 56 in an upper section 58 of the spindle diffuser 53.

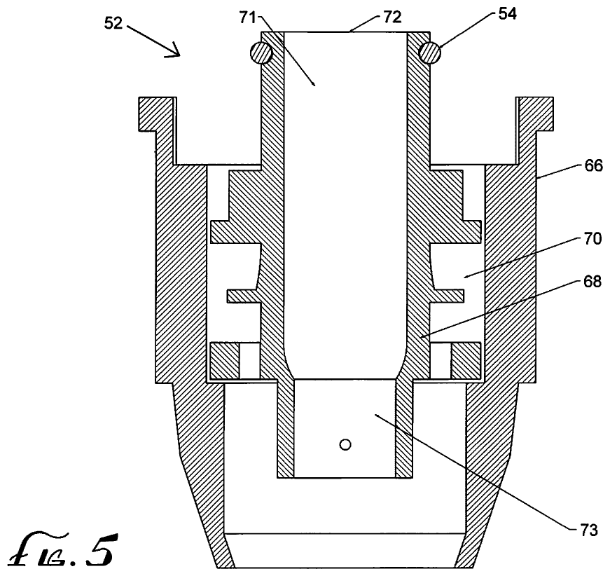

With reference to FIGS. 4, 5 and 9, the nozzle 52 has an outer wall 66 and an inner wall 68 with an annular flow path 70 between the walls 66 and 68. There is a central flow path 71 down through the nozzle, with an inlet 72 and an outlet 73 for forward flow, and sanitizing liquid can flow from the central flow path 71 with 73 as the inlet and exiting the annular flow path 70. The inlet 72 used for the beverage can be used for introduction of the sanitizing fluid into each nozzle assembly 15 or there can be reverse flow by introduction of sanitizing fluid through the manifolds 41 or soda gun nozzle configuration. Arrows 104 show the half symmetry example of reverse flow for a soda gun nozzle starting in the outer annulus and exiting the central flow path for cleaning of the O ring. Arrows 106 show the half symmetry example of reverse flow for a soda gun nozzle starting in the central flow path and exiting the annulus for cleaning of the soda gun nozzle diffuser face.

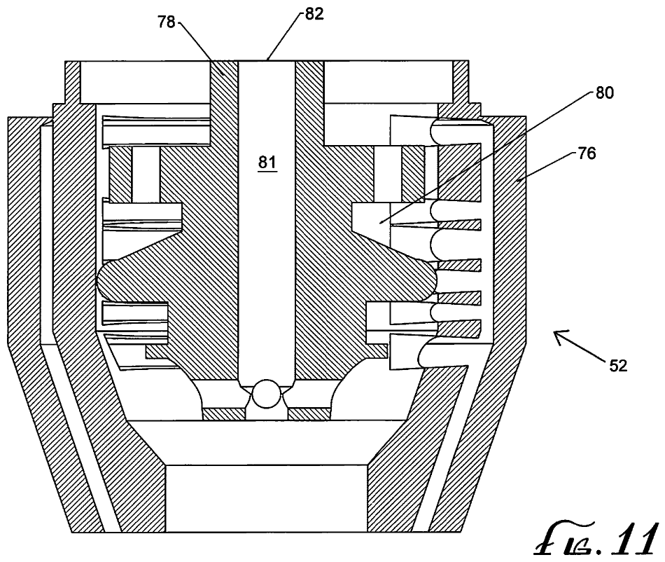

With reference to FIG. 11, a nozzle 74 that is useful for a soda fountain is shown. The nozzle 74 has an outer wall 76 and an inner wall 78 with an annular flow path 80 between the walls 76 and 78. There is a central flow path 81 down through the nozzle, and sanitizing liquid can flow between the central flow path 81 and the annular flow path 80. An inlet 82 used for the beverage can be used for introduction of the sanitizing fluid into the nozzle 74 or there can be reverse flow.

In addition to the first sensor 26, as noted above, the sensor 40a (see FIGS. 1 and 2) can be provided in the line 39 used for reverse sanitizing liquid flow. The sensors 26 and 40a again can be pressure sensors, flow rate sensors, and/or temperature sensors.

A bottom valve 95 (FIGS. 1 and 2), which can be electronically controlled by the controller 40, is used for controlling the direction of sanitizing liquid flow, either up the annular flow path 70 or 80 and down the center, or up the center and down the annular flow path.

An interlock utilizing a pressure sensor 97 and mechanical lock 96 (see FIG. 7) for the soda gun on the support 42 is provided for preventing sanitizing fluid flow into the nozzles when the nozzles are not engaged to receive sanitizing liquid. A similar interlock pressure sensor 97a and mechanical lock (FIG. 2A) can be used on the attachment 14a. For example, the interlock prevents sanitizing liquid flow when the source valve 22 is open.

A holster 98 (FIGS. 7 and 8) is used for the soda gun 11. A holster is commonly used for a soda gun, but the holster 98 is adapted for use with the invention. The holster is supported by a support 42, also referred to as a holder. The holster has an outer wall 100 and an inner wall 101 with an annular flow path 102 between the walls 100 and 101. There is a central flow path 103 through the holster with an inlet 124. The drain 125 for exit of the sanitizing liquid is provided.

It is desirable for a system having multiple nozzles, such as a soda fountain machine 14 and soda gun with one nozzle and buttons for selection of beverage flow path in 11a, that all the nozzles and flow paths be cleaned simultaneously. For this purpose, a pressure plate 128 can be provided (see FIG. 2A and FIG. 7) that opens all the nozzles and button flow paths simultaneously.

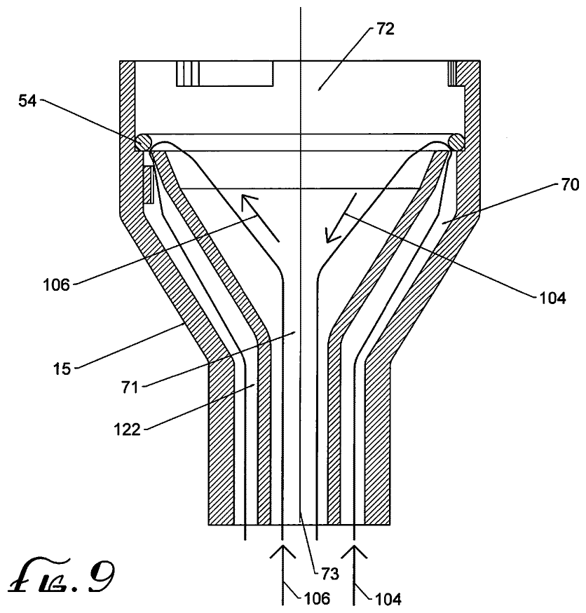

For forward flow of the sanitizing fluid, with reference to FIG. 9, sanitizing fluid can pass through the nozzle inlet 72 and out the outlet 73 through the central flow path 71 in a single pass. Optionally by opening or closing the valve 95, sanitizing liquid in reverse flow can flow upwardly through the annular flow path 70, wherein it can contact and sanitize the O-ring 54, and then downwardly through the middle via the central flow path 71. Alternatively sanitizing liquid can flow up through the middle and down through the annular flow path 70 as shown by arrows 120 in FIG. 9. Sanitizing fluid is discharged through the drain outlet 125. Thus, the sanitizing liquid can have flow through the annular flow path and the middle flow path (or reverse).

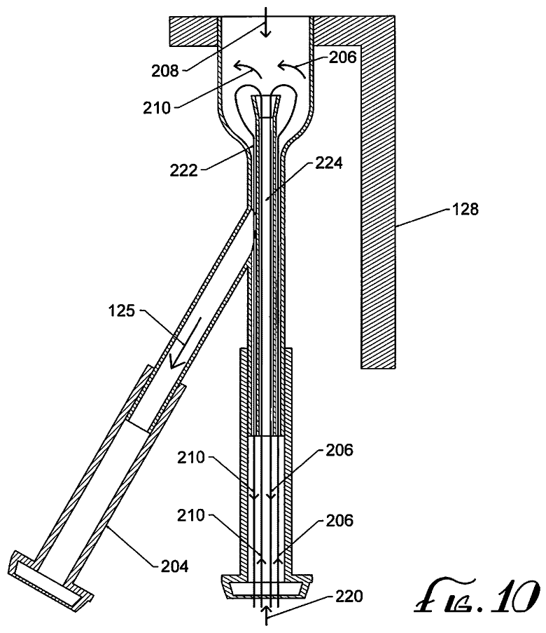

With reference to FIG. 10, reverse and forward flow is shown for the cleaning attachment. The drain is a manifold attachment 204. Reverse flow is shown in half symmetry by arrows 206 from an inlet 220 upwardly through an annular path 222 and down central path 224 and arrow 125 out the drain 204, or by arrows 210 up central path 224 from an inlet 220 upwardly and down an annular path 222 and arrow 125 out the drain 204 and forward flow of the sanitizing fluid is shown by arrows 208 from an inlet down a central flow path 224 and arrow 125 out the drain 204.

### Automated Control System

### Sensor Description

A control system 270 for operating the beverage dispensing system 10 includes a controller 40 which operates the system in conjunction with a sensor suite 234. The controller 40 may be a conventional computer system, i.e. microprocessor executing instructions or may be an artificial intelligence (“AI”).

With reference to FIGS. 1-2, sensor suite 234 will typically include one or more oxygen or O2 sensors 236, microbial content sensors 238, film buildup sensors 240, turbidity sensors 242, chlorine content sensors 244, Brix sensors 246, water hardness sensors 248, pH sensors 250, alkalinity sensors 252, total dissolved solids or TDS sensors 254, and, water conductivity sensors 256. The sensor suite 234 may also include one or more flow rate sensors 262, pressure sensors 264, temperature sensors 258 and motion sensors 260. The function and purpose of the above listed sensors are discussed below.

A suitable O2 sensor 236 for use with the controller 40 is an optically based, dissolved oxygen sensor which uses luminescence to measure the dissolved oxygen in beverages or water. One commercially available sensor suitable for use as the O2 sensor 236 is the Sensorex Lumin-S Optical DO Sensor. Sensors of this type use a luminescent cap that changes intensity based on oxygen concentration, measured optically.

In the exemplary embodiment, the O2 sensor 236 is installed in line 24, which is a line between source valve 22 and soda gun 11 in the embodiment of FIG. 1 or the source valve 22 and soda fountain dispenser 14, in the embodiment of FIG. 2. In the present invention, preferably, sensing takes place in the beverage as it is dispensed to prevent oxidation of the beverage which may occur if the sensor were located in a storage tank.

The controller 40 in conjunction with the O2 sensor 236 tracks dissolved oxygen levels to optimize a deaeration process. A deaeration process is the process of removing dissolved gases, primarily oxygen and carbon dioxide, from liquids. The O2 sensor 236 functions as a part of a feedback loop operated by the controller 40 that adjusts deaeration or nitrogen flushing to minimize oxygen exposure. A dissolved oxygen level in a fluid which is either too high or too low may indicate aeration issues or contamination which could cause the controller 40 to trigger activation of a cleaning cycle. The controller 40 by monitoring the O2 sensor 236 allows for low dissolved oxygen levels in beverages for improving product shelf life and flavor stability. Optical dissolved oxygen sensors are low maintenance and well suited for beverage applications.

A suitable microbial content sensor 238 for use with the controller 40 can be either an electrochemical or an optical based sensor which detects microbial contamination (e.g., E. coli, coliforms) using PCR or fluorescence-based methods. In the exemplary embodiment the microbial content sensor 238 is located in line 24. Electrochemical, potentiometric sensors operate by measuring changes in ion activity due to microbial metabolism. Optical fluorescence sensors operate by detecting microbial DNA or proteins. Sampling is typically done offline or in a bypass loop. One commercially available sensor suitable for use as the microbial content sensor 238 is the Bio-Rad iQ-Check Real-Time PCR System.

Sensing with the microbial content sensor 238 occurs in the beverage (via sampling) or in rinse water to detect pathogens. The sensor 238 preferably is not directly inline due to sensitivity requirements. The controller 40 uses the microbial sensor 238 to track microbial trends to validate sanitation protocols. High microbial counts indicate inadequate cleaning or biofilm formation and can cause the controller 40 to trigger one or more additional disinfection cycles.

The controller 40 in conjunction with the microbial sensor 238 ensures compliance with food safety regulations. Real-time microbial detection is challenging and requires periodic sampling of the beverage being monitored.

The film buildup sensor 240 for use with the controller 40 tracks film buildup in beverage tanks and lines. In the exemplary embodiment the film build up sensor 240 is located in line 24. The Sensorex S8000 pH Sensor or Endress+Hauser OUSTF10 can be adapted for this purpose. pH sensors like the Sensorex S8000 detect coating on electrodes, while turbidity sensors like OUSTF10 detect emulsions or residues indicative of film buildup. pH sensors monitor signal drift due to coating, while turbidity sensors detect scattered light from films or emulsions. These sensors are typically installed in dispensing lines.

The controller 40 in conjunction with the film buildup sensor 240 tracks buildup trends in order to schedule maintenance. Cleaning cycles are triggered if buildup exceeds predetermined levels. Proper cleaning prevents flavor carryover or contamination in multi-product lines. Film buildup detection often relies on indirect measurements (e.g., pH drift or turbidity spikes).

The turbidity sensor 242 for use with the controller 40 tracks the level of suspended particles in the beverage to be dispensed. In the exemplary embodiment the turbidity sensor 242 is located in line 24. The turbidity sensor emits light into the beverage and measures scattered light caused by suspended particles (e.g., yeast, sediment). The sensor is installed inline in the dispensing line to monitor the beverage as it's dispensed, which ensures a real-time clarity assessment without product loss.

A commercially available sensor suitable for use as the turbidity sensor 242 is the Endress+Hauser Turbimax CUS52D. This sensor is a smart turbidity sensor for inline measurement in beverage production, compliant with ISO 7027 for low to medium turbidity ranges. It uses nephelometric principles with an LED and a 90-degree light detector. This sensor's self-cleaning features (e.g., ultrasonic cleaning) minimize maintenance, making it suitable for continuous operation.

The controller 40 in conjunction with the turbidity sensor 242 tracks turbidity trends to optimize filtration processes or detect batch inconsistencies. The controller 40 adjusts dispensing parameters (e.g., flow rate, filtration) if turbidity exceeds acceptable levels. High turbidity may indicate filter clogging or residue buildup, signaling cleaning needs. Monitoring of turbidity ensures compliance with beverage clarity standards (e.g., for beer or soft drinks).

Chlorine content sensors use an electrode to generate a current proportional to chlorine concentration in the water or beverage. Such sensors are typically paired with a transmitter for the transmission of real-time data. In the exemplary embodiment the chlorine content sensor 242 is located in line 25, which is disposed between the beverage source 16 and the check valve 20. One such sensor suitable for use as the chlorine content sensor 244 of the present invention is the Sensorex CLD Series Chlorine Dioxide Sensor. This sensor is an amperometric sensor for measuring residual chlorine or chlorine dioxide in water. The sensor is used in beverage processing and has a detection range suitable for disinfection monitoring.

The chlorine content sensor 244 is located in a water supply. Chlorine sensors are not, typically, disposed directly in the dispensed beverage, as chlorine is a disinfectant, not a beverage component.

The controller 40 in conjunction with the chlorine content sensor 244, monitors chlorine levels to ensure consistent disinfection over time. The controller 40 based on readings from the chlorine content sensor 244 adjusts chlorine dosing in water. The controller 40 verifies adequate chlorine in water to ensure sanitation and to ensure compliance with food safety regulations (e.g., FDA standards for pathogen control). Chlorine sensors are important for verifying water quality in beverage production to prevent microbial contamination.

A Brix sensor is a sensor that measures the refractive index of a beverage as light passes through it, which correlates to sugar content. In the exemplary embodiment the Brix sensor 246 is located in line 25, which is disposed between the beverage source 16 and the check valve 20. One commercially available sensor suitable for use as the Brix sensor 246 of the present invention is an Anton Paar L-Rix 500 sensor. This sensor is an inline refractometer for real-time Brix measurement in beverages, using refractive index to determine sugar concentration with high accuracy (±0.1% Brix).

Sensing with the Brix sensor 246 takes place in the beverage being dispensed, to ensure accurate sugar levels in soft drinks, juices, or syrups.

The controller 40 uses data from the Brix sensor 246 to track Brix consistency across product batches for quality control and to adjust syrup/water ratios in real time to maintain target Brix levels. Deviations in Brix levels may indicate syrup residue or line contamination, which may trigger a cleaning cycle. Monitoring and maintaining Brix levels can improve flavor profiles and can ensure compliance with product specifications. Brix sensors are important for carbonated beverage dispensers to maintain consistent taste.

The water hardness sensor 248 is a sensor that uses reagents to induce a color change proportional to hardness ions, measured via colorimetry. One commercially available sensor suitable for use as the water hardness sensor 248 of the present invention is the Hach SP510 Hardness Analyzer. This sensor is a colorimetric analyzer for measuring calcium and magnesium levels (water hardness) in process water, with automated titration for accuracy.

The water hardness sensor 248 is installed in the water supply used for beverage preparation—not in the dispensed beverage, as water hardness affects equipment scaling and water quality.

The controller 40 uses data from the water hardness sensor 248 to adjust conventional water softening processes to prevent scaling in dispensers or boilers. High water hardness can indicate scale buildup, triggering descaling procedures. Water hardness control is critical to prevent scale deposits in dispensing systems and has the additional benefits of extending equipment life and assisting in maintaining beverage taste from batch to batch.

The pH sensor 250 is a sensor that uses a glass electrode to measure hydrogen ion concentration, generating a voltage proportional to pH. In the exemplary embodiment, the pH sensor 250 is located in line 25, which is disposed between the beverage source 16 and the check valve 20. A commercially available pH sensor suitable for use as the pH sensor 250 of the present invention is the Sensorex S8000 Modular pH Sensor. This sensor uses replaceable cartridges and is suitable for continuous monitoring in beverage production. It is also resistant to coating and fouling.

The pH sensor 250 is placed in the beverage being dispensed (e.g., to monitor acidity in sodas or juices) or in process water for cleaning. The controller 40 tracks data from the pH sensor 250 to ensure product consistency and detect process deviations. The controller 40 implements a feedback loop to adjust acid or base dosing to maintain a target pH for flavor or product preservation and to ensure compliance with food safety and taste profiles. The controller 40 also tracks pH levels in rinse water as abnormal pH levels may indicate residual cleaning agents in the water. pH sensors are versatile for both product quality and sanitation monitoring.

The alkalinity sensor 252 is a sensor that performs automated titration with acid to measure alkalinity and may be paired with pH data for accuracy. In the exemplary embodiment, the alkalinity sensor 252 is located in line 25, which is disposed between the beverage source 16 and the check valve 20. A commercially available alkalinity sensor suitable for use as the alkalinity sensor 252 of the present invention is the Hach TU5300sc Alkalinity Analyzer. This sensor is a laser-based turbidimeter with titration capabilities for measuring bicarbonate and carbonate ions in water, used in beverage processing.

The alkalinity sensor 252 is in the water supply for beverage preparation or cleaning, as alkalinity affects pH stability and scaling. The controller 40 tracks data from the alkalinity sensor 252 and uses that data to adjust water treatment to stabilize pH and prevent scaling. High alkalinity may indicate improper rinsing, signaling cleaning issues. Monitoring alkalinity ensures water quality for consistent beverage production. Alkalinity sensors help maintain equipment efficiency by preventing scale formation.

The total dissolved solids or TDS sensor 254 is a sensor that measures electrical conductivity between two electrodes, correlating to TDS. In the exemplary embodiment, the TDS sensor 254 is located in line 25, which is a line disposed between the beverage source 16 and the check valve 20. A commercially available TDS sensor suitable for use as the TDS sensor 254 of the present invention is the Atlas Scientific Conductivity/TDS Sensor. This sensor is a conductivity-based sensor for measuring total dissolved solids in water or beverages, with a range of 0-2,000,000 μS/cm (per Google its “Microsiemens Per Centimeter (μS/cm),” which is a unit in the category of Electrical conductivity.)

The TDS sensor 254 is installed in the water supply or the beverage being dispensed, depending on the application (e.g., water purity or beverage consistency). The controller 40 tracks data from the TDS sensor 254 to assess water or beverage quality over time and adjusts filtration solution blending to maintain target TDS levels. Elevated TDS in rinse water may indicate contamination or residue. The controller 40 ensures compliance with beverage standards (e.g., mineral content in bottled water). TDS sensors are critical for both water treatment and final product quality.

The conductivity sensor 256 is a sensor that senses the ability of a solution to conduct electricity between electrodes, proportional to ion concentration. A commercially available conductivity sensor suitable for use as the alkalinity sensor 252 of the present invention is the Sensorex CS8000 Conductivity Sensor. The sensor is a modular graphite electrode sensor for measuring ionic content in water or beverages, with a wide range (0-2,000,000 μS/cm).

The conductivity sensor 256 is installed in the water supply or the beverage being dispensed, depending on whether monitoring water purity or beverage composition. The controller 40 tracks data from the conductivity sensor to monitor process stability by adjusting water treatment or ingredient dosing to maintain a target conductivity.

The controller 40 receives data from the conductivity sensor 256 to verify water quality for brewing or bottling applications. High conductivity in rinse water can indicate residual chemicals. Conductivity is closely related to TDS and is used for similar purposes.

All of the sensors used by the controller 40 contribute to historical data for process optimization, quality control, and regulatory compliance. Most of the sensors (Brix, pH, DO, chlorine, etc.) are actively monitored by the controller 40 and feedback loops enable real-time adjustments to maintain product quality or system efficiency. The turbidity, microbial, pH, conductivity, and film buildup sensors are used by the controller 40 to identify cleaning needs and/or verify sanitation. The controller 40 further uses its sensor suite to ensure food safety, extend equipment lifespan, and meet consumer taste expectations.

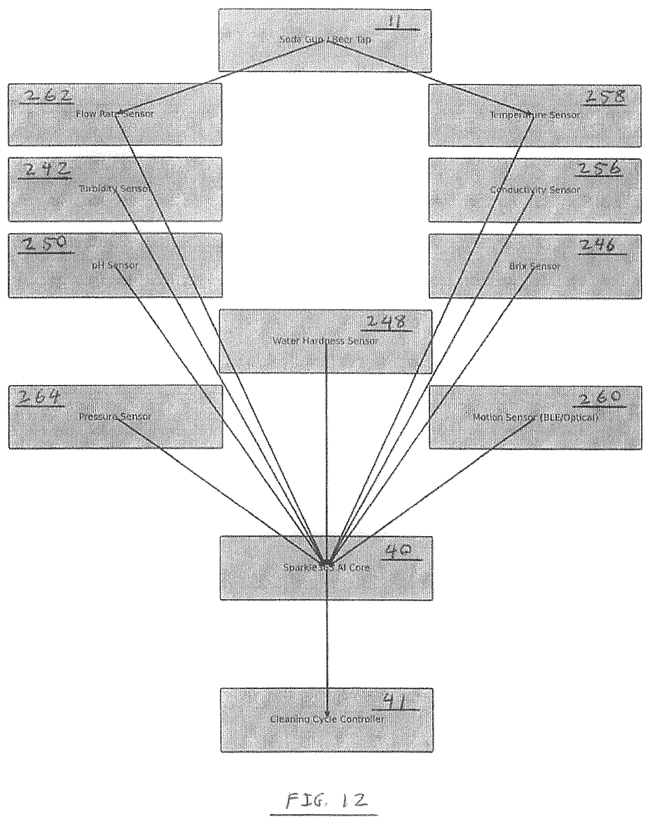

Additional sensors that may be included in the sensor suite 234 include flow rate sensors 262, pressure sensors 262, temperature sensors 258 and motion sensors 260, as shown in FIG. 12. These sensors monitor fluid flow, pressure and temperature, respectively. Motion sensors 260 may also be included in the sensor suite. These sensors monitor when fluid lines are in use.

The control system 270 of the present invention may, in various embodiments, use some or all of the above-described sensors.

One embodiment of the control system 270, using a subset of the sensors described above, is control system 270A, which is depicted in FIG. 12. Control system 270A uses the following sensors:

Flow Rate Sensors 262. Purpose: Monitor the volume and frequency of liquid flow through each beverage line. Use: Detect usage patterns and trigger cleaning cycles based on flow thresholds. Type: Hall Effect Turbine Flow Sensor; Range: 0.3-6.0 L/min; Accuracy: ±3% of reading; Resolution: 0.1 L/min; Output: Digital Pulse (PWM).

Temperature Sensors 258. Purpose: Detect temperature of dispensing lines. Use: Ensure optimal conditions for sanitation and identify abnormal operation or bacterial risk zones. Type: Digital NTC Thermistor (Waterproof, stainless steel); Range: −40° C. to +125° C.; Accuracy: ±0.5° C. (0 to 100° C.); Resolution: 0.1° C.; Update Rate: 1 reading/sec.

Turbidity Sensors 242. Purpose: Detect particulate and microbial load in rinse water. Use: Measure cleanliness and determine end-point of cleaning cycle. Type: Nephelometric (Optical Backscatter); Range: 0-1000 NTU; Accuracy: ±2% FS or ±0.5 NTU (whichever is greater); Resolution: 0.1 NTU; Light Source: 850 nm IR LED.

Conductivity Sensors 256. Purpose: Confirm presence and concentration of cleaning agents. Use: Validate that detergent and sanitizer concentrations meet required levels. Type: Graphite-based or Stainless Steel Conductivity Probe; Range: 0-20,000 μS/cm. Accuracy: ±2% of reading; Resolution: 10 μS/cm; Cell Constant: K=1.

pH Sensors 250. Purpose: Monitor the acidity or alkalinity of fluid in lines. Use: Ensure chemical balance during cleaning and verify neutralization at rinse. Type: Glass Electrode with ATC; Range: 0-14 pH; Accuracy: ±0.1 pH; Resolution: 0.01 pH; Temperature Compensation: Yes (automatic).

Brix Sensor 246. Purpose: Measure sugar concentration in soda lines (° Bx). Use: Detect syrup calibration issues, flag over-concentration or dilution, and optimize cleaning frequency based on sugar load. Type: Hall Effect Turbine Flow Sensor; Range: 0.3-6.0 L/min; Accuracy: ±3% of reading; Resolution: 0.1 L/min; Output: Digital Pulse (PWM).

Water Hardness Sensor 248. Purpose: Measure calcium and magnesium ion content in inlet water. Use: Predict scale buildup, adjust cleaning cycles and detergent mix, and extend equipment longevity. Type: Ion-selective electrode (Calcium/Magnesium detection); Range: 0-500 ppm CaCO₃; Accuracy: ±10 ppm; Resolution: 1 ppm; Output: Analog or Digital.

Pressure Sensors 264. Purpose: Detect pressure variances during cleaning and dispensing. Use: Identify blockages, leaks, or mechanical malfunctions.

Line Presence/Motion Sensors 260 (BLE or Optical). Purpose: Detect when a line is actively used or moved. Use: Trigger cleaning events or send inactivity alerts for unused lines. Type: Bluetooth 5.0 Beacon; Transmission Power: −30 to +4 dBm; Battery Life: 1-2 years (depending on TX interval; Broadcast Interval: 500 ms-2 s; Range: 30-80 m indoor (depending on environment).

In operation, the controller 40 of the control system 270A continuously monitors and analyzes sensor data to schedule and optimize cleaning based on usage patterns, sugar content, and microbial risk. The system 270A adapts detergent and rinse cycles based on pH, turbidity, and conductivity results; extends hardware lifespan by responding to water hardness and pressure anomalies; generates compliance logs with time-stamped validation for sanitation events; alerts maintenance teams in case of failure, flow anomalies, or calibration issues. When needed, the controller 40 instructs a cleaning cycle controller 41 (see FIG. 12) to initiate a cleaning cycle.

Although the present invention is being described in considerable detail with reference to preferred versions, other versions are possible. Therefore, the scope of the appended claims should not be limited to description herein.

What is claimed is:

1. A system for cleaning a beverage dispenser, comprising:
a) a nozzle for receiving at least one beverage and a sanitizing fluid, the nozzle including:
b) a housing having an outer wall and an inner wall with an annular flow path between the walls;
c) a central flow path through the nozzle;
d) a nozzle inlet for introduction into the nozzle of alternately the beverage or of the sanitizing fluid, the nozzle inlet receiving the beverage from a beverage source and receiving the sanitizing fluid from a sanitizing fluid source; and
e) wherein the nozzle is configured so that introduced sanitizing fluid can flow into the annular flow path from the central flow path.

2. The system of claim 1, wherein the sanitizing fluid comprises a liquid, the system including a sanitizing liquid source and a sanitizing liquid line for the liquid to flow between the sanitizing liquid source and the nozzle inlet.

3. The system of claim 2, further including a heater for heating sanitizing liquid before the sanitizing liquid reaches the nozzle inlet.

4. The system of claim 3, further including a controller for controlling the heater, and wherein the system includes a temperature sensor for sensing the temperature of the sanitizing liquid, the temperature sensor being capable of providing an output to the controller based on the sensed temperature.

5. The system of claim 2, further including a pump for pumping the liquid from the sanitizing liquid source to the nozzle, a controller for controlling the pump, and a flow rate sensor for sensing the flow rate of the liquid and being capable of providing an output to the controller based on the sensed flow rate.

6. The system of claim 1, further including an interlock for preventing sanitizing fluid from flowing into the nozzle when the nozzle is not engaged to receive the sanitizing fluid.

7. The system of claim 1, further including an O-ring to provide a seal for avoiding fluid leakage and wherein sanitizing fluid flowing in the nozzle contacts the O-ring.

8. The system of claim 1, comprising a pressure sensor for sensing the pressure of the sanitizing fluid.

9. The system of claim 1, wherein the dispenser is a soda gun and includes a holster for the nozzle.

10. The system of claim 10, wherein the holster comprises a drain outlet for discharge of the sanitizing fluid from the nozzle.

11. The system of claim 1, further including a plurality of nozzles with a valve for each nozzle for allowing or preventing the beverage from flowing into the respective nozzle, and including a pressure plate for opening all the valves simultaneously.

12. The system of claim 1, further including a plurality of the nozzles for dispensing different beverages, each nozzle comprising a valve for opening and closing the respective nozzles, and a pressure plate for opening all the valves simultaneously for flow of the sanitizing fluid through the valves simultaneously.

13. The system of claim 1, further including an attachment for the nozzle, the attachment including a valve with an open position and a closed position, wherein in the closed position sanitizing liquid cannot pass out of the valve.

14. The system of claim 13 wherein the attachment for the nozzle comprises a drain outlet for discharge of sanitizing liquid from the nozzle.

15. A nozzle for dispensing a beverage comprising:
a.) a housing having an outer wall and an inner wall with an annular flow path between the walls and a central flow path through the nozzle inside the inner wall;
b.) an opening inlet for introduction into the nozzle of alternately the beverage or a sanitizing liquid into the nozzle, the inlet receiving the beverage from a source for the beverage and the sanitizing liquid from a source for the sanitizing liquid; and
c.) wherein the nozzle is configured so that introduced sanitizing liquid can flow into the annular flow path from the central flow path.

16. A system for cleaning a beverage dispenser comprising a nozzle for receiving at least one beverage and a sanitizing fluid, the nozzle comprising:
a) a housing having an outer wall and an inner wall with an annular flow path between the walls;
b) a central flow path through the nozzle;
c) a connection for fluid flow of the sanitizing fluid between the central flow path and the annular flow path; and
d) an inlet for introduction of the sanitizing fluid;
e) a controller;
f) a valve system controllable by the controller comprising:
i. a beverage valve having an open and closed position for allowing or preventing the beverage from entering the nozzle; and
ii. a sanitizing fluid valve for allowing or preventing the sanitizing fluid from entering the nozzle; and
g) a pump for pumping sanitizing fluid into the nozzle.

17. The system of claim 16 wherein the controller includes memory for storing information about when the sanitizing fluid valve was open for allowing the sanitizing liquid to enter the valve.

18. A method for cleaning the nozzle of the system of claim 1, the nozzle comprising the inlet and an outlet for the beverage, the method comprising the step of pressuring the sanitizing fluid into the inlet and to the annular flow path.

19. A method for cleaning the nozzle of the system of claim 1, the nozzle comprising an inlet and an outlet for the beverage, the method comprising the step of pressuring sanitizing fluid into the outlet and then into the annular flow path, and then to the central flow path.

20. A control system for operating a beverage dispensing device, comprising:
a controller responsive to input from a sensor suite;
the sensor suite having at least one of the following:
a flow rate sensor, wherein the controller uses the flow rate sensor to monitor a flow rate of a fluid in a line to trigger a cleaning cycle based on a predetermined minimum flow rate level;
a temperature sensor, wherein the controller uses the temperature sensor to monitor a temperature of the fluid to identify a bacterial risk zone;
a turbidity sensor, wherein the controller uses the turbidity sensor to monitor a particulate level in the fluid, wherein if the particulate level exceeds a predetermined level, the controller initiates a cleaning cycle and terminates the cleaning cycle when the particulate level is reduced below a predetermined level;
a conductivity sensor, wherein the controller uses the conductivity sensor to confirm a concentration of a cleaning agent in the fluid is at a predetermined level;
a pH sensor, wherein the controller uses the pH sensor to monitor an acidity level of the fluid to ensure a predetermined acidity level is maintained;
a Brix sensor, wherein the controller uses the Brix sensor to monitor a sugar concentration in the fluid to initiate a cleaning cycle when the sugar concentration exceeds a predetermined level;
a water hardness sensor, wherein the controller uses the water hardness sensor to monitor a calcium ion concentration in in the fluid and initiates a cleaning cycle if calcium ion concentration exceeds a predetermined level;
a pressure sensor, wherein the controller uses the pressure sensor to monitor pressure in the fluid in the line to trigger an alert signal if the pressure exceeds or drops below a preset maximum or minimum pressure level; and
a motion sensor, wherein the controller senses motion of the line to determine if the line is in use.
